(19) United States
(12) Patent Application Publication
(10) Pub. No.: US 2022/0071286 A1
(43) Pub. Date: Mar. 10, 2022

(54) CERAMIC ATOMIZER

(71) Applicant: Shenzhen Eigate Technology Co., Ltd., Shenzhen (CN)

(72) Inventor: Tuanfang LIU, Shenzhen (CN)

(21) Appl. No.: 17/117,103

(22) Filed: Dec. 9, 2020

(30) Foreign Application Priority Data
Sep. 7, 2020 (CN) 202021933459.4

(51) Int. Cl. A24F 40/46; A24F 40/10; H05B 3/42

(52) U.S. Cl. CPC A24F 40/46; H05B 3/42; A24F 40/10

(57) ABSTRACT

A device includes a ceramic core and a metal heating wire. The ceramic core includes a body including a through hole.

### CROSS-REFERENCE TO RELATED APPLICATIONS

Pursuant to 35 U.S.C.§ 119 and the Paris Convention Treaty, this application claims foreign priority to Chinese Patent Application No. 202021933459.4 filed on Sep. 7, 2020, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to a ceramic atomizer.

Conventionally, the ceramic atomizer of the electronic cigarettes is spiral structure with a single cylindrical hole. Thus, the heating area of the ceramic atomizer is small and thus the electronic cigarettes can only produce a small amount of vapor.

### SUMMARY

The disclosure provides a device, comprising a ceramic core and a metal heating wire; wherein the ceramic core comprises a body comprising a through hole.

In a class of this embodiment, the metal heating wire comprises a first pat which is a curved meshed structure disposed in the through hole, and a second part which is a pin extended out of the body of the ceramic core.

In a class of this embodiment, the metal heating wire comprises one or more curved meshed structures, planar helical structures, spiral structures, or a combination thereof connected in series or in parallel.

In a class of this embodiment, the through hole is round, and two pins are extended out of the body.

In a class of this embodiment, two pins are soldered on two sides of the one or more curved meshed structures for electric conduction to heat the metal heating wire.

In a class of this embodiment, the body comprises one or more through holes in the shape of circle, ellipse, square, triangle and polygon.

In a class of this embodiment, the body of the ceramic core is cylindrical.

In a class of this embodiment, the body of the ceramic core is in the shape of ellipsoid, flat ellipse, hemisphere, cone, bowl, triangle, quadrilateral, polygon; and the ceramic core is an equivalent of quartz, crystal, mica, agate, jade.

### BRIEF DESCRIPTION OF THE DRAWINGS

FIG. 1 is an exploded view of a ceramic atomizer in accordance with one embodiment of the disclosure;

FIG. 2 is a schematic diagram of a ceramic atomizer in accordance with one embodiment of the disclosure; and

FIG. 3 is a sectional view of a ceramic atomizer in accordance with one embodiment of the disclosure.

### DETAILED DESCRIPTION

To further illustrate, embodiments detailing a ceramic atomizer are described below. It should be noted that the following embodiments are intended to describe and not to limit the disclosure.

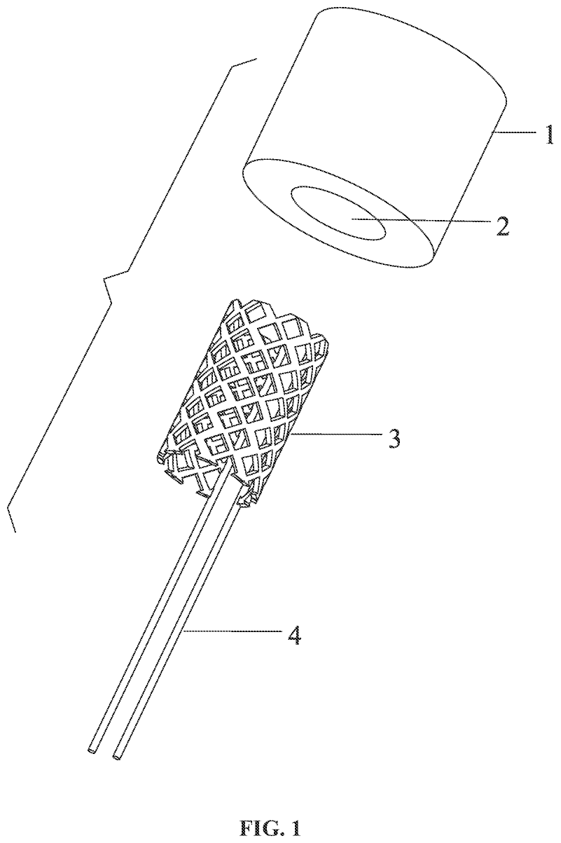

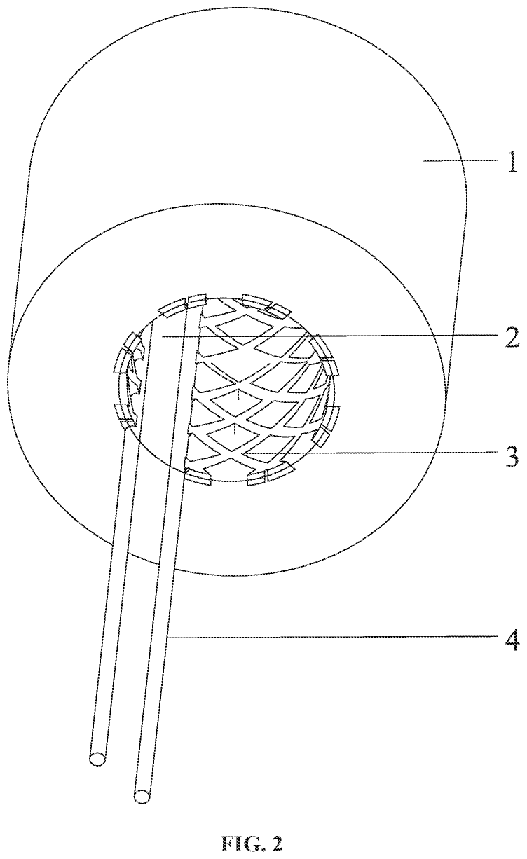

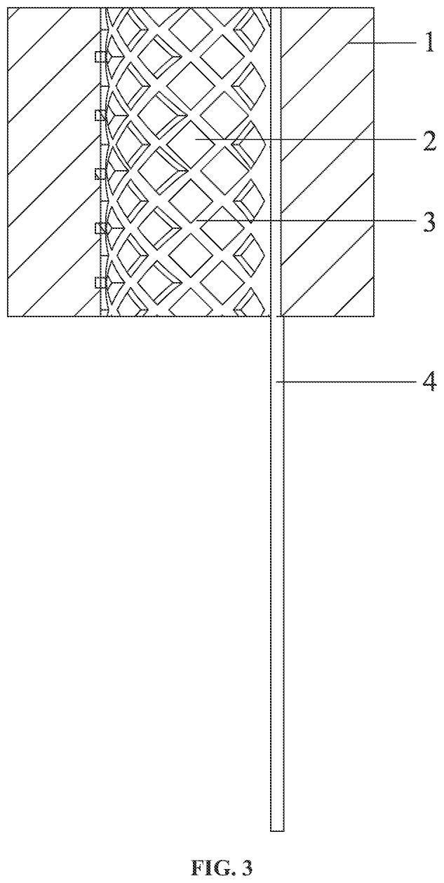

As shown in FIGS. 1-3, the disclosure provides a ceramic atomizer comprising a ceramic core 1 and a metal heating wire 3. The ceramic core 1 comprises a body comprising a round through hole 2, and two pins 4 secured to the body for electric conduction. In certain embodiments, the ceramic core 1 comprises one round through hole and one metal heating wire. The metal heating wire 3 is a curved meshed structure. The metal heating wire 3 is disposed in the ceramic core 1 or exposed in the round through hole 2. The two pins 4 are electrified to make the metal heating wire 3 heated, and the heat is transferred to the ceramic core 1 to atomize the e-liquid.

The following advantages are associated with the ceramic atomizer of the disclosure:

1. The body of the ceramic core is cylindrical, which is easy to manufacture. The metal heating wire comprises one or more curved meshed structures, which enlarges the heating area, increases the heat value, accelerates temperature rise and increases the vapor amount.

2. The metal heating wire is in the shape of curved meshed structure, which is novel.

It will be obvious to those skilled in the art that changes and modifications may be made, and therefore, the aim in the appended claims is to cover all such changes and modifications.

What is claimed is:

1. A device, comprising a ceramic core and a metal heating wire; wherein the ceramic core comprises a body comprising a through hole.

2. The device of claim 1, wherein the metal heating wire comprises a first pat which is a curved meshed structure disposed in the through hole, and a second part which is a pin extended out of the body of the ceramic core.

3. The device of claim 2, wherein the metal heating wire comprises one or more curved meshed structures, planar helical structures, spiral structures, or a combination thereof connected in series or in parallel.

4. The device of claim 3, wherein the through hole is round, and two pins are extended out of the body.

5. The device of claim 4, wherein two pins are soldered on two sides of the one or more curved meshed structures for electric conduction to heat the metal heating wire.

6. The device of claim 5, wherein the body comprises one or more through holes in the shape of circle, ellipse, square, triangle and polygon.

7. The device of claim 6, wherein the body of the ceramic core is cylindrical.

8. The device of claim 7, wherein the body of the ceramic core is in the shape of ellipsoid, flat ellipse, hemisphere, cone, bowl, triangle, quadrilateral, polygon; and the ceramic core is an equivalent of quartz, crystal, mica, agate, jade.
